(19) United States
(12) Patent Application Publication
(10) Pub. No.: US 2025/0047041 A1
(43) Pub. Date: Feb. 6, 2025

(54) ELECTRICAL CONNECTOR WITH IMPROVED GROUNDING MEMBERS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HUNG-CHI YU, New Taipei (TW); Wen-Lung Hsu, New Taipei (TW); Xun Wu, Huaian (CN); Yong-Chun Xu, Kunshan (CN); Tian Yang, Kunshan (CN); Ming-Yi Gong, Huaian (CN)

(21) Appl. No.: 18/792,048

(22) Filed: Aug. 1, 2024

(30) Foreign Application Priority Data
Aug. 3, 2023 (CN) 202310971082.3
Aug. 3, 2023 (CN) 202310973612.8

(51) Int. Cl. H01R 13/6471; H01R 12/72; H01R 13/02; H01R 13/405; H01R 13/639

(52) U.S. Cl. CPC H01R 13/6471; H01R 13/02; H01R 13/405; H01R 13/639; H01R 12/721

(57) ABSTRACT

An electrical connector includes: an insulating housing; one row of terminals including signal and grounding terminals, each terminal including a retaining portion, an elastic arm and a soldering portion, and an arc-shaped contacting portion extending from the elastic portion, the contacting portion having a contacting point, the soldering portion having a nearest soldering point; and a grounding member comprising plural first grounding portions arranged in one row and each extending slantwise downwards and plural second grounding portions arranged in one row and each extending slantwise upwards, the first grounding portions touch the grounding terminals at first touching points, the second grounding portions touch the grounding terminals at second touching points, the first touching point is located at a middle-length point between the contacting point and the nearest soldering point along an extending direction of the grounding terminal, and the second touching point is located near the first touching point.

### BACKGROUND OF THE INVENTION

### 1. Field of the Invention

The present invention relates to a high speed electrical connector with improved grounding members.

### 2. Description of Related Art

China Patent No. CN217062592U discloses a card edge connector which includes a longitudinal insulating housing, plural conductive terminals, and two grounding members. The grounding members are retained on the side walls of the insulating housing and located at outsides of retaining portions of the terminals. The grounding member includes first grounding fingers and second grounding fingers aligned in an upright direction one by one. The first grounding finger and the aligned second grounding finger contact the retaining portion of same grounding terminal.

U.S. Pat. No. 20,230,411912A1 discloses an electrical connector which includes a longitudinal insulating housing, plural differential-pair signal terminals and plural grounding terminals, and a grounding plate module retained in the insulating housing. The grounding plate module has an electromagnetic interference (EMI) absorber and a grounding plate retained in the EMI absorber. The grounding plate defines plural grounding fingers extending out of the EMI absorber to contact with corresponding grounding terminals.

U.S. Pat. No. 8,545,240 discloses placing a grounding bar or any other communing structure to couple two ground terminals together at their physical mid-point can cut the electrical length of the connector approximately in half and therefore raise the resonant frequency by doubling it. Moreover, it is better that each grounding terminal has multiple contacting points with the grounding bar. But different electrical connectors may need grounding bars of different shapes, especially the contacting positions of the grounding bars and the grounding terminals, which cause much time and cost to design.

### SUMMARY OF THE INVENTION

The instant invention is to provide an electrical connector with an improved grounding member.

To achieve the above-mentioned object, an electrical connector comprises: an insulating housing; one row of terminals arranged in the insulating housing and comprising signal terminals and grounding terminals, each of the terminals comprising a retaining portion retained in the insulating housing, an elastic arm and a soldering portion extending from opposite ends of the retaining portion, and an arc-shaped contacting portion extending from the elastic portion, the contacting portion having a contacting point, the soldering portion having a nearest soldering point to the retaining portion; a grounding member attached in the insulating housing and comprising plural first grounding portions arranged in one row and each extending slantwise downwards and plural second grounding portions arranged in one row and each extending slantwise upwards; wherein the first grounding portions touch the grounding terminals at first touching points, the second grounding portions touch the grounding terminals at second touching points, the first touching point is located at a middle-length point between the contacting point and the nearest soldering point along an extending direction of the grounding terminal, and the second touching point is located near the first touching point.

To achieve the above-mentioned object, an electrical connector comprises: an insulating housing; one row of terminals arranged in the insulating housing and comprising signal terminals and grounding terminals, each of the terminals comprising a retaining portion retained in the housing, an elastic arm and a soldering portion extending from opposite ends of the retaining portion, and an arc-shaped contacting portion extending from the elastic portion, the contacting portion having a contacting point, the soldering portion having a nearest soldering point to the retaining portion; a grounding member attached in the insulating housing and comprising plural first grounding portions arranged in one row and each extending slantwise upwards, plural second grounding portions arranged in one row and each extending slantwise upwards, and plural third grounding portions arranged in one row and each extending slantwise downwards; wherein the first grounding portions touch the grounding terminals at first touching points, the second grounding portions touch the grounding terminals at second touching points, the third grounding portions touch the grounding terminals at third touching points, the first touching point is located at a middle-length point between the contacting point and the nearest soldering point along an extending direction of the grounding terminal, the second touching point is located near the contacting points, and the third touching point is located near the nearest soldering point.

### BRIEF DESCRIPTION OF THE DRAWINGS

FIG. 1 is a top perspective view of an electrical connector mounted on a PCB of a first embodiment in accordance with the present invention;

FIG. 2 is a bottom perspective view of the electrical connector in FIG. 1;

FIG. 3 is a cross-sectional view of the electrical connector taken along line A-A in FIG. 1;

FIG. 4 is an exploded perspective view of the electrical connector in FIG. 2;

FIG. 5 is another exploded view of the electrical connector without the insulating housing in FIG. 4;

FIG. 6 is a side elevational view of the electrical connector in FIG. 5, which is inserted with a card module;

FIG. 7 is a top perspective view of an electrical connector mounted on a PCB of a second embodiment in accordance with the present invention;

FIG. 8 is a bottom perspective view of the electrical connector in FIG. 7;

FIG. 9 is a cross-sectional view of the electrical connector taken along line B-B in FIG. 7;

FIG. 10 is an exploded perspective view of the electrical connector in FIG. 8;

FIG. 11 is another exploded view of the electrical connector without the insulating housing in FIG. 10; and

FIG. 12 is a side elevational view of the electrical connector in FIG. 11, which is inserted with a card module.

### DETAILED DESCRIPTION OF THE PREFERRED EMBODIMENT

Reference will now be made in detail to the preferred embodiments of the present invention.

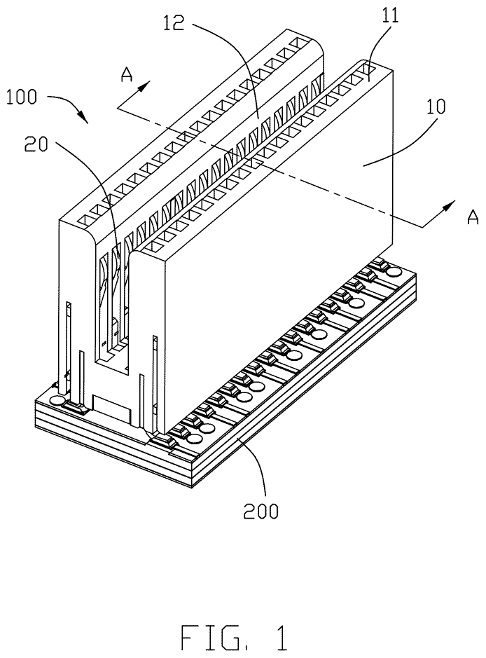

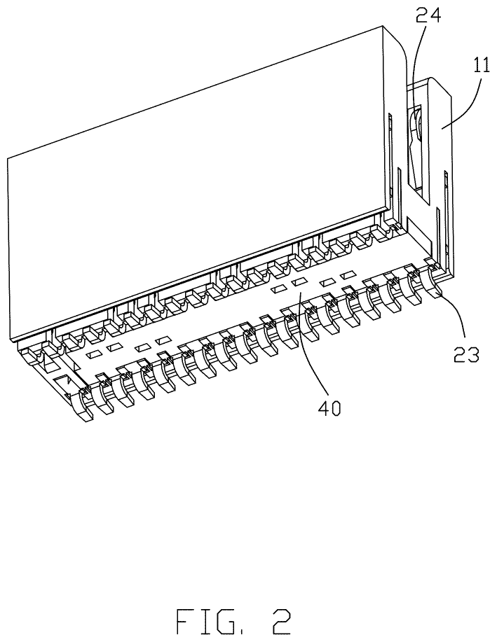

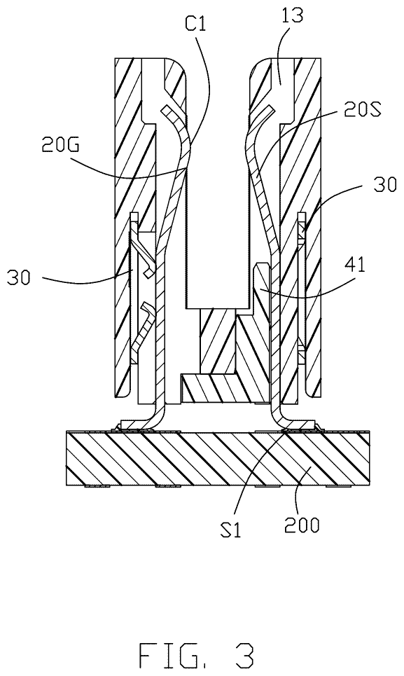

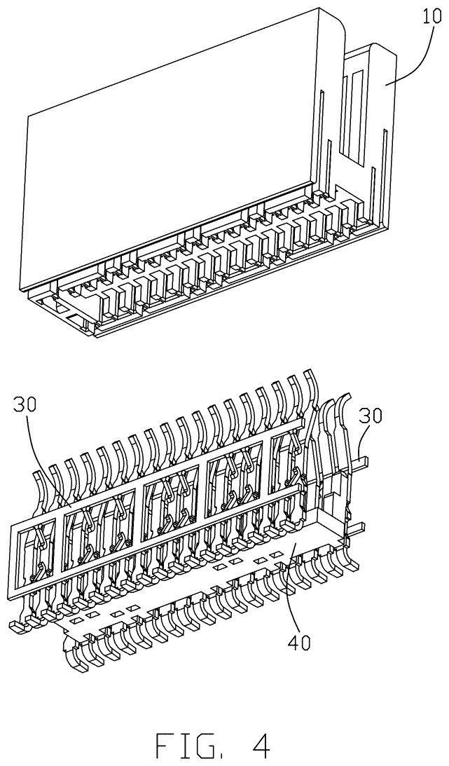

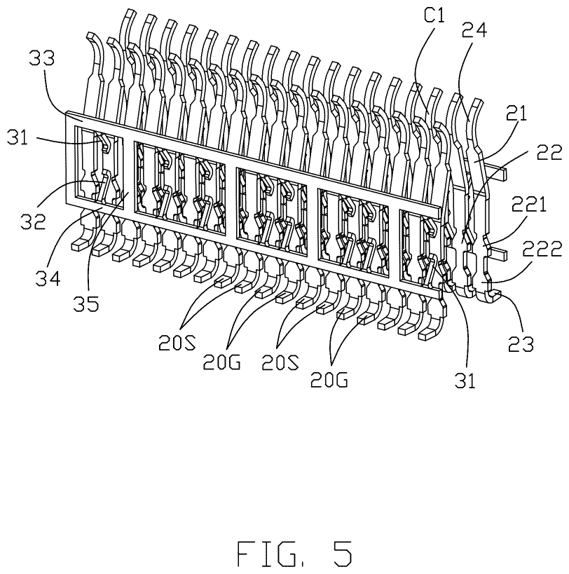

Referring to FIGS. 1-6 illustrating a first embodiment of the present invention, an electrical connector 100 is of a card edge connector which is mounted on a printed circuit board 200 for being inserted with a PCI express card or module. The electrical connector 200 includes a longitudinal insulating housing 10 and two rows of terminals 20, only part of the electrical connector 100 is shown in the figures. The housing 10 includes two side walls 11 and a mating slot 12 between the two side walls 11 and opening upwards. The mating slot 12 is longitudinal, and each side wall 11 is loaded with one row of terminals 20.

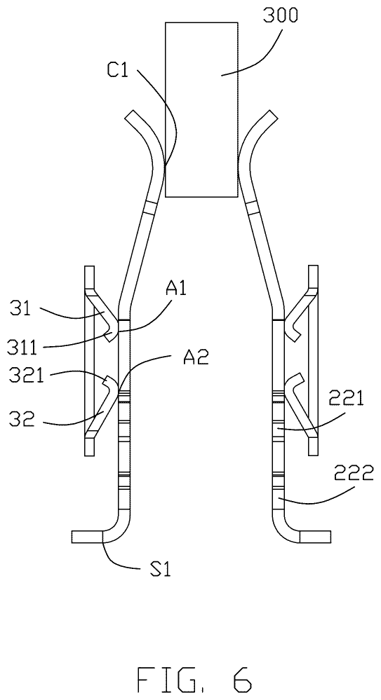

The terminals 20 includes retaining portions 22 retained in the housing 10 and elastic arms 21 extending slantwise upwards from upper ends of the retaining portions 22 and soldering portion 23 bending outwards from lower ends of the retaining portions 22. The elastic arms 21 have arc-shaped contacting portions 24 protruding into the mating slot 12. In this embodiment, the contacting portion 24 become smaller than the elastic arm 21 in size in the longitudinal direction. The contacting portion 24 has a contacting point C1 which touches the card module 300 when the card module 300 is inserted into the mating slot 12 as shown in FIG. 6. The soldering portion 23 is horizontal and has a bottom soldering face which has a point at a joint the soldering face and the retaining portion 22, naming the jointing point as a nearest soldering point S1 to the retaining portion.

Each row of terminals 20 includes plural signal terminals 20S and plural grounding terminals 20G, two adjacent signal terminals 20S are constructed as a pair of differential signal terminals. Two adjacent pairs of differential signal terminals are separated with one or two grounding terminals 20G. The row of terminals 20 also include other functional terminals, such as power terminals, grounding terminals and detecting terminals. The side walls 11 have passageways 13 and the terminals 20 are inserted into the passageways 13 from a bottom of the housing 10.

Two grounding members 30 are added at outsides of the two rows of terminals 20 and touch with corresponding grounding terminals 20G respectively, to shift the resonance frequency to high value thereby improving high speed performance. Each of the grounding members 30 has plural first grounding portions 31 and plural second grounding portions 32. The first grounding portions 31 are arranged in one row, each first grounding portion 31 extends slantwise downwards to press against a first touching point A1 of the grounding terminal. The second grounding portions 32 are arranged in one row, each second grounding portion 32 extends slantwise upward to press against a second touching point A2 of the same grounding terminal. The first touching point A1 is located at a middle-length point of the portion between the contacting point C1 and the nearest soldering point S1 in an extending direction of the grounding terminals. The nearer the second touching point A2 is located to the first touching point A1, the smaller the NEXT (Near-end crosstalk) of the electrical connector becomes, thereby benefitting the high frequency performance of the electrical connector 100.

In this embodiment, each of the grounding members 30 include an upper bar 33, a lower bar 34 and plural upright bars 35 connecting with the upper and lower bars. Some upright bars 35 are severed near a middle point thereof and then bend to form the first and second grounding portions 31, 32. The first grounding portions 31 extend downward from a lower edge of the upper bar 33. The second grounding portions 32 extend from an upper edge of the lower bar 34. The first grounding portions 31 are designed to have a shortest length but provide enough length to ensure enough elastic forces to press against the first touching points A1. The second grounding portions 32 are designed to have a longest length but provide enough length to ensure enough elastic force to press against the second touching points A2. That is, a combination of the first and second grounding portions 31, 32 in a straight statue or before bending has a same length with the upright bar 35. Free ends of the first and second grounding portions 31, 32 in a straight status are located without a clearance or the clearance being infinite close zero. In this embodiment, a largest distance between the first touching point A1 and the second touching points A2 is 1.5 mm. The first and second grounding portions have free ends 311, 321 arced away from the grounding terminals 20G, The free ends are used to protect the grounding portions.

The retaining portion 22 has an upper interfering portion 221 and a lower interfering portion 222, the first touching point A1 is located proximate to the root of the retaining portion 22 connecting to the elastic arm 21. The second touching portion A2 is located at the root proximate to the upper interfering portion 221. A filled member 40 is inserted into the housing from a bottom of the housing, which includes an inserting portion 41 inserted and filled with the signal passageways 13, to change dielectric material around the signal terminals 20S.

It is understood that said embodiment offers a method of how to quickly define the grounding portions of the grounding members with a high speed performance.

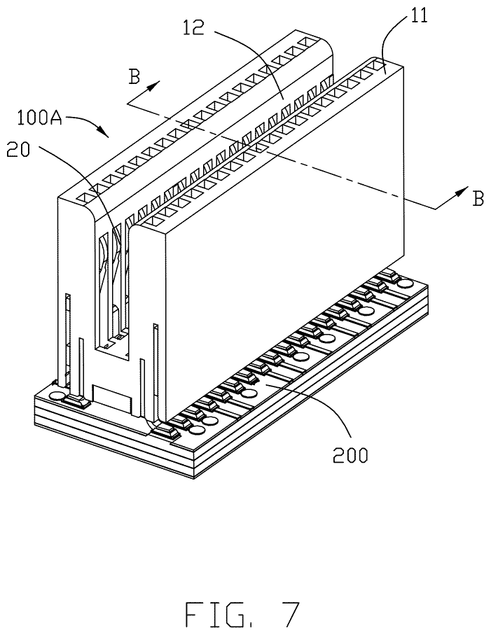

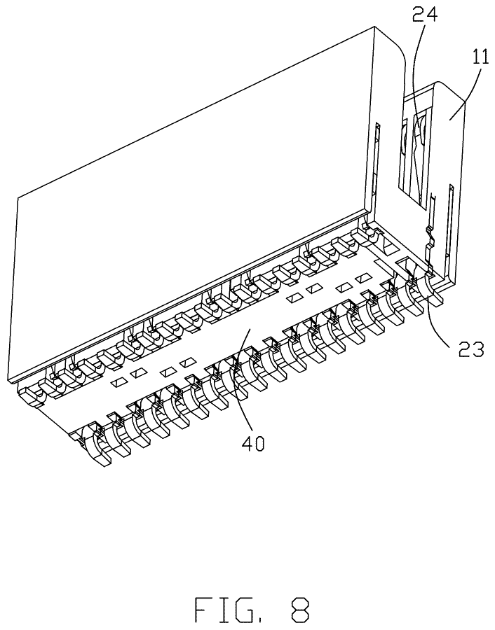

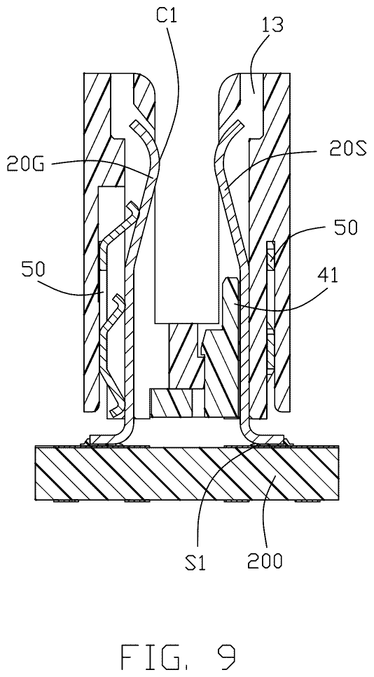

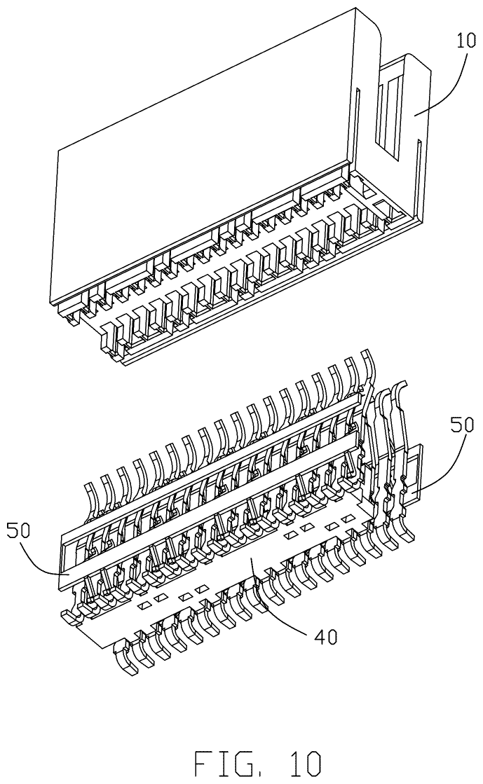

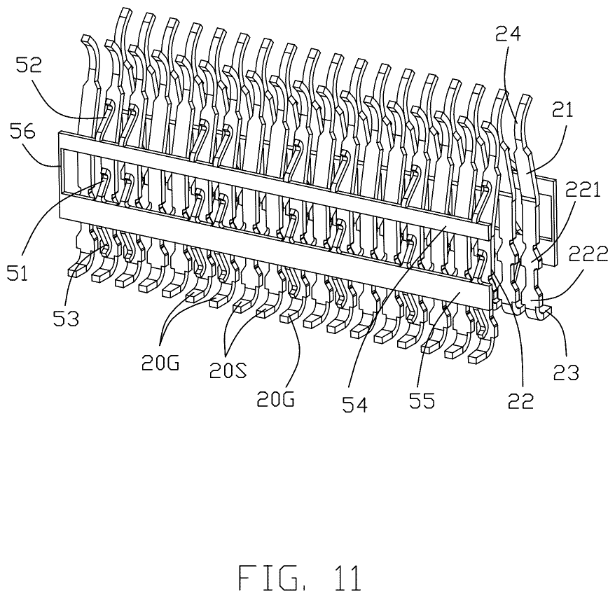

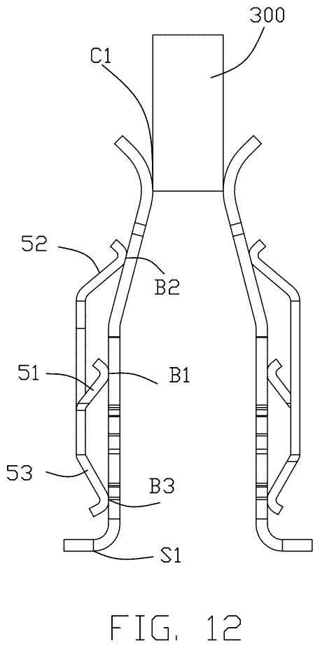

Referring to FIGS. 7-12 illustrating a second embodiment of this present invention, the electrical connector 100A is same to the electrical connector 100 of the first embodiment, except the grounding members 50. The same elements are labeled with the same numerals, and is not described hereinafter.

Each of the grounding members 50 includes plural first grounding portions 51, plural grounding portions 52 and plural grounding portions 53. The first grounding portions 51 are ranged in one row, each extends slantwise upwards and touches the first touching points B1 of corresponding grounding terminals 20G. The second grounding portions 52 are ranged in one row, each extends slantwise upwards and touches the second touching points B2 of corresponding same grounding terminals 20G. The third grounding portions 53 are ranged in one row, each extends slantwise downwards and touches the third touching points B3 of corresponding same grounding terminals 20G. It is noted that the first touching point B1 is located at a middle-length point between the contacting point C1 and the nearest soldering point S1, the second touching point B2 is located proximate to the contacting point C1, the third touching point B3 is located proximate to the nearest soldering point S1. The nearer the second touching point B2 is located to the contacting point C1, the nearer the third touching point B3 is located to the soldering point S1, the smaller the NEXT value become, thereby benefiting to improve the high frequency performance of the electrical connector.

In this embodiment, the grounding member 50 include an upper bar 54, a lower bar 55 and plural upright bar 56 connecting with the upper and lower bars. The first grounding portions 51 extend slantwise upwards from an upper edge of the lower bar 55. The second grounding portions 52 extend slantwise upwards from an upper edge of the upper bar 54. The second grounding portions 52 are designed to have a longest length to make the second touching points B2 locate nearer the contacting point C1. The third grounding portions 53 are designed to have a longest length to make the third touching points B3 locate nearer the soldering point S1. It is noted that the grounding portions must have enough length to ensure enough elastic force to press against the grounding terminals. The grounding portions have free ends arced away from the grounding terminals. In this embodiment, the upper interfering portions 221 and lower interfering portions 222 protruding laterally, the third touch points B3 are located below the lower interfering portions 222, the first touching points B1 are located at the retaining portion 22 above the upper interfering portions 221, the second touching points B2 are located on the elastic arms 21. According said two embodiments, the grounding portions can quick be designed, avoiding much time and cost.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulating housing;
one row of terminals arranged in the insulating housing and comprising signal terminals and grounding terminals, each of the signal terminals and the grounding terminals comprising a retaining portion retained in the insulating housing, an elastic arm and a soldering portion extending from opposite ends of the retaining portion, and an arc-shaped contacting portion extending from the elastic portion, the contacting portion having a contacting point, the soldering portion having a nearest soldering point to the retaining portion; and
a grounding member attached in the insulating housing and comprising plural first grounding portions arranged in one row and each extending slantwise downwards and plural second grounding portions arranged in one row and each extending slantwise upwards;
wherein the first grounding portions touch the grounding terminals at first touching points, the second grounding portions touch the grounding terminals at second touching points, the first touching point is located at a middle-length point between the contacting point and the nearest soldering point along an extending direction of the grounding terminal, and the second touching point is located near the first touching point.

2. The electrical connector as claimed in claim 1, wherein free ends of the first grounding portion and corresponding grounding portions are located close to each other without any clearance after the first and second grounding portions are in a straight status.

3. The electrical connector as claimed in claim 1, wherein the first grounding portions are designed to have a shortest length and the second grounding portions are designed to have a longest length.

4. The electrical connector as claimed in claim 1, wherein the grounding member comprises an upper bar, a lower bar, and plural upright bars connecting with the upper bar and the lower bar, the first grounding portions extend downwards from a lower edge of the upper bar, and the second grounding portion extend upwards from an upper edge of the lower bar.

5. The electrical connector as claimed in claim 4, wherein the first and second grounding portions are formed by cutting and bending the grounding member.

6. The electrical connector as claimed in claim 4, wherein free ends of the first grounding portions and the second grounding portions are arced away from the grounding terminals.

7. The electrical connector as claimed in claim 4, wherein a largest distance between the second touching point and the first touching point is 1.5 mm.

8. The electrical connector as claimed in claim 1, wherein the first touching points and the second touching points are located on the retaining portions.

9. The electrical connector as claimed in claim 8, wherein each of the retaining portions defines an upper interfering portion and a lower interfering portion, and the first and the second touching points are located above the upper interfering portions.

10. An electrical connector comprising:
an insulating housing;
one row of terminals arranged in the insulating housing and comprising signal terminals and grounding terminals, each of the signal terminals and the grounding terminals comprising a retaining portion retained in the housing, an elastic arm and a soldering portion extending from opposite ends of the retaining portion, and an arc-shaped contacting portion extending from the elastic portion, the contacting portion having a contacting point, the soldering portion having a nearest soldering point to the retaining portion; and
a grounding member attached in the insulating housing and comprising plural first grounding portions arranged in one row and each extending slantwise upwards, plural second grounding portions arranged in one row and each extending slantwise upwards, and plural third grounding portions arranged in one row and each extending slantwise downwards;
wherein the first grounding portions touch the grounding terminals at first touching points, the second grounding portions touch the grounding terminals at second touching points, the third grounding portions touch the grounding terminals at third touching points, the first touching point is located at a middle-length point between the contacting point and the nearest soldering point along an extending direction of the grounding terminal, the second touching point is located near the contacting points, and the third touching point is located near the nearest soldering point.

11. The electrical connector as claimed in claim 10, wherein the first grounding portions are designed to have a shortest length and the second grounding portions and the third grounding portions are designed to have a longest length.

12. The electrical connector as claimed in claim 10, wherein the grounding member comprises an upper bar, a lower bar, and plural upright bars connecting with the upper bar and the lower bar, the first grounding portions extend upwards from an upper edge of the lower bar, the second grounding portions extend upwards from an upper edge of the upper bar, and the third grounding portions extend downwards from a lower edge of the lower bar.

13. The electrical connector as claimed in claim 10, wherein the second touching points are located on the elastic arms, and the first and second grounding portions are located on the retaining portions.

14. The electrical connector as claimed in claim 10, wherein free ends of the first and second and third grounding portions are arced away from the grounding terminals.
